(19) United States
(12) Patent Application Publication
(10) Pub. No.: US 2004/0237087 A1
(43) Pub. Date: Nov. 25, 2004

(54) Job scheduling techniques to reduce the variance of waiting time

(76) Inventors: Nong Ye, Tempe, AZ (US); Xueping Li, Tempe, AZ (US); Toni Farley, Tempe, AZ (US); Harish Bashettihalli, Tempe, AZ (US)

Correspondence Address: GALLAGHER & KENNEDY, P. A., 2575 E. CAMELBACK RD. #1100, PHOENIX, AZ, 85016, US

(21) Appl. No.: 10/842,865

(22) Filed: May 10, 2004

Related U.S. Application Data
(60) Provisional application No. 60/469,178, filed on May 8, 2003.

(51) Int. Cl. G06F 9/46

(52) U.S. Cl. 718/101

(57) ABSTRACT

Job scheduling techniques to reduce the variance of waiting time for stable performance delivery jobs from requesting entities such as PCs connected by a network to a resource such as a server in batches. Each batch contains N or less jobs. A first, waiting buffer can receive the requests and a second, processing buffer receives each batch from the waiting buffer. A batch of jobs to be processed are arranged by a routine called the “Yelf Spiral” in which the list of jobs is begun by placing the smallest job at the center of the list and each succeeding larger job (the next smallest) is placed alternately to the left and right of the smallest job until the largest job has been placed on the list. The jobs are then performed in the order that places the largest job last.

### RELATED APPLICATIONS

This application claims priority from United States provisional patent applications Ser. No. 60/469,178 entitled The Yelf Spiral: “A Job Scheduling Technique to Reduce the Variance of Waiting Time for Stable Performance” filed May 8, 2003 of Nong Ye, Xueping Li and Toni Farley, Serial No. 60/477,103 entitled “Batch Scheduled Admission Control” filed Jun. 9, 2003 of Nong Ye, Toni Farley and Harish Bashettihalli. Both of the above provisional applications are hereby incorporated by reference.

### STATEMENT OF GOVERNMENT FUNDING

Financial assistance for this project was provided by the U.S. Government, Air Force Office of Sponsored Research/Department of Defense No. F49620-01-1-0317. The United States Government has certain rights to this invention.

### BACKGROUND

Job scheduling seeks to efficiently use a resource that is being called upon to perform numerous jobs in tandem. An object in job scheduling is to reduce job waiting time and job waiting time variance.

“Job waiting time” is the time from the receipt of a job request by an entity being requested to do the job to the time that entity begins the job. “Variance” of job waiting time is a term understood in the art and is determined as follows. For a series of n jobs determine the average waiting time:

$${t}_{avg .} = \frac{{t}_{1} + {t}_{2} + {t}_{3} … + {t}_{n}}{n}$$

where: t_{avg.} is the average weighting time of jobs 1, 2, 3 . . . n, t₁, t₂, t₃, . . . tₙ are waiting times of jobs 1, 2, 3 . . . n, respectively. The variance of job waiting times, v, is:

$$v = \frac{{( {t}_{1} - {t}_{avg .} )}^{2} + {( {t}_{2} - {t}_{avg .} )}^{2} + {( {t}_{3} - {t}_{avg .} )}^{2} … + {( {t}_{n} - {t}_{avg .} )}^{2}}{n - 1} .$$

In a network environment 10 of FIG. 1 jobs usually arrive for processing at a resource 12 in an exponential fashion. That is to say, the probability distribution of the inter-arrival times of the jobs is exponential. In other words, if one plots the time between job arrivals for a set of jobs, the distribution of the plot will be exponential. The resource 12 may be a Web Server on the Internet. In this scenario today's Web Servers will typically attempt to process these jobs using some technique that is designed for exponentially arrived jobs. Such techniques usually lead to a high variance in the waiting time of the jobs.

### SUMMARY

In accordance with one aspect, the present invention job scheduling uses a batch scheduled admission control scheme or technique. In a computer environment, such as the internet, other networks, either LAN or WAN or other applications in which job processing takes place at the request of multiple stations, remote PCs or other clients, for example, two job buffers are employed. One is a “waiting” buffer and the other is a “processing buffer.”

Jobs are collected in the waiting buffer as they arrive until an entire batch of size N has arrived. Next, the jobs are sorted into the Processing buffer for processing. The time axis for processing jobs is slotted and batches are processed at fixed time intervals. If a time slot arrives and there are K<N jobs ready to process, then those K jobs will be processed as a batch.

At processing time the time to complete the jobs in the Processing buffer is computed. An announcement is then sent to incoming job requests, giving the time that the next batch of jobs will be processed. Thus when a new job arrives in the system it can readily be determined when that job will be scheduled for processing. This bounds the waiting time of the job. The key is to select a time slot and batch size that can most effectively handle the traffic load. These parameters can be set in a static or dynamic fashion.

By batching the jobs as they arrive the required resources that perform the jobs view the jobs as having arrived at the same time. Using this admission control technique enables the use of job scheduling algorithms, such as the Yelf Spiral, that is a further aspect of the present invention. Such algorithms only work on sets of jobs that arrive at once. As described below, the Yelf Spiral has been shown to reduce the variance in the waiting time of jobs requesting resources. Thus the batch scheduled admission control technique acts as a “first step” to obtain reduced variance.

The Yelf Spiral is a technique for determining the order of jobs to be serviced in such a way that the variance of their waiting times is reduced. The technique involves scheduling the jobs in a spiral fashion based on their processing times. Like the batch scheduled admission control technique, this ordering technique has commercial applications in any situation where jobs require scheduling and reducing the variance in the job waiting times would prove beneficial. Such applications exist in almost all fields, including computers, cabled or wireless computer network, Internet, electric power networks, transportation networks, and others. An example would be scheduling web requests (jobs) in a web server. By reducing the variance of web request waiting times, user expectations can more easily be established and met.

Using the Yelf Spiral technique a list or queue of jobs to be performed is assembled in a special way. Formation of the list of jobs is always started with the smallest job (i.e. the job that will take the least time). The list always ends with the biggest job (i.e. the job that will take the longest time). However the smallest job is placed in the center of the list and each next bigger job is placed first on one side of the smallest job then on the other side. The jobs are processed in the order of the list starting at the end remote from the biggest job and proceeding through jobs, including the smallest job on to the biggest job. As described more fully below, the ordering of jobs can be viewed as a spiral, the Yelf Spiral.

Using the batch scheduled admission control of the invention with the Yelf Spiral job ordering, waiting time variance is minimized.

The above and further features of the invention will be better understood from the following detailed description of a preferred embodiment or embodiments taken in consideration with the accompanying drawings.

### BRIEF DESCRIPTION OF THE DRAWINGS

FIG. 1 is a diagrammatic illustration of a computer installation such as a web server in combination with a network such as the Internet and equipped to the batch scheduled admission control of the invention;

FIG. 2 is a diagrammatic rendering of the batch scheduled admission control of nine jobs in accordance with the invention;

FIG. 3 is a diagrammatic illustration of the formation of a job list or queue using the Yelf Spiral technique of the invention;

FIG. 4 is another diagrammatic illustration of the formation of a job list or queue using the Yelf Spiral technique of the invention; and

FIG. 5 is a flow chart diagrammatically illustrating the scheduling method of this invention.

### DETAILED DESCRIPTION

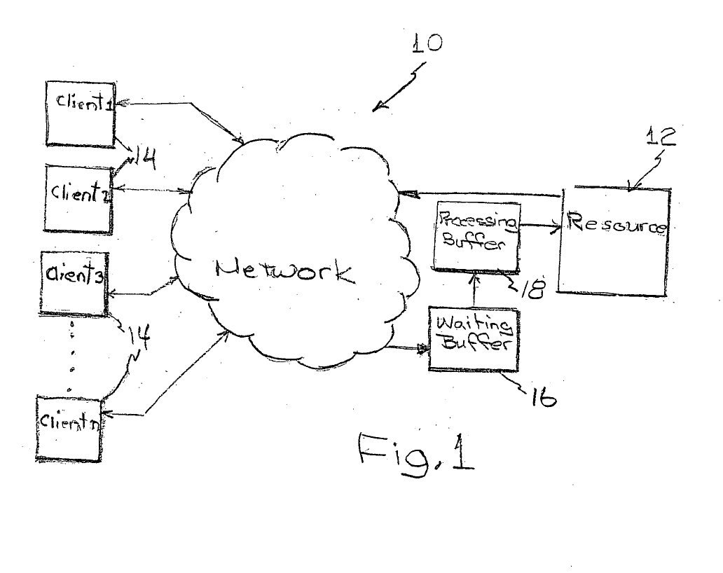

Turning to FIG. 1, there is shown a network 10 interconnecting a resource 12 with multiple client's 14, identified as clients 1, 2, 3 . . . n. The clients 14 request actions by the resource 10, which requested actions are termed “jobs” here. At the site of the resource 12 a first buffer, the “waiting” buffer 16 receives jobs. A second buffer 18, the “processing” buffer, receives jobs in batches from the waiting buffer 16.

Jobs requested by the clients 14 are collected in the waiting buffer 16 as they arrive until an entire batch of size N has arrived. The jobs are then sorted into the processing buffer 18 for processing by the resource 12. The time axis for processing jobs is slotted and batches are processed at fixed time intervals. If a time slot arrives and there are K<N jobs ready to process, then those K jobs will be processed as a batch.

At processing time, the time to complete the jobs in the processing buffer 18 is computed and communicated to the clients providing incoming job requests, giving the time that the next batch of jobs will be processed. Thus when a new job arrives in the system, it can readily be determined when that job will be scheduled for processing. This bounds the waiting time of the job.

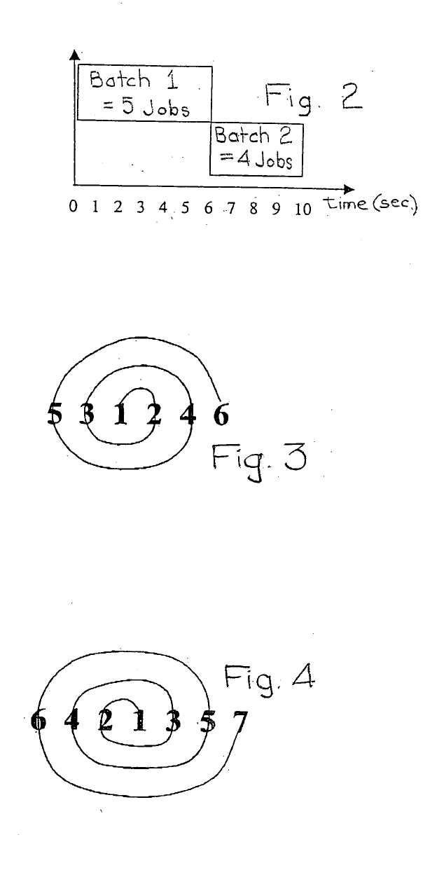

As an example, consider nine jobs numbered 1-9. Under the batch scheduled admission control scheme of the invention, with N=5, these jobs would be batched as shown in FIG. 2.

In this example the first five jobs are batched in a group, Batch 1, and scheduled in the processing buffer 18 using ordering rules applied to obtain a desired performance characteristic such as reduced variance in job waiting times. At time=0 it is calculated that the set of jobs in the processing buffer will take six seconds to process. Thus the processing time of the next batch is announced to be at time=6. At time=6 there are only four jobs in the waiting buffer so these four jobs will be the next batch, Batch 2, and will be sorted into the processing buffer. Now the ordering rules can be applied to this batch to obtain our desired performance characteristic. If before time=6, five jobs have been accepted into the waiting buffer and there are more jobs arriving, those additional jobs are rejected and the requesting entity or client is advised to come back at a later time or turn to other similar resources for service.

In the Yelf Spiral there exists a variety of circumstances where a set of many jobs must be scheduled to run on one resource. For example, a web server often needs to schedule multiple requests for processing. Minimizing the variance in the waiting of such jobs before being serviced can provide stability and predictability to a system. In the web server example, by minimizing the variance in the waiting times of the jobs, one can set tighter bounds on waiting time for providing Quality of Service (QoS) to the user. The Yelf Spiral is a job ordering method that can be shown to reduce the variance in waiting times of a set of jobs.

Consider a set of an even number of jobs with processing times 1, 2, 3, 4, 5, 6. The Yelf Spiral method will order these jobs in such a way that the variance in their waiting time is reduced. The method proceeds as follows:

1. The smallest job is identified and a job list is started by placing the smallest job in the middle of the list;

2. The next smallest job is then identified and placed at the end of the list (to the right in the example of FIG. 3);

3. The next smallest job is identified and placed at the beginning of the list (to the left in the FIG. 3 example); and

4. Steps 2-3 are then repeated for the remaining jobs.

In the example the jobs are thus ordered as follows: 5, 3, 1, 2, 4, 6. This is the order in which the jobs are performed beginning at the left. The technique can be thought of a as spiral, called here the Yelf Spiral, due to the nature of the ordering method as shown in FIG. 3. The Yelf Spiral requires that the job with the longest processing time is always completed last. Thus, for an odd number of jobs, the spiral proceeds in a counter-clockwise direction as follows:

1. The smallest job is identified and the job list is again started by placing the smallest job in the middle of the list of FIG. 4;

2. The next smallest job is identified and placed at the beginning of the list (to the left in the example of FIG. 4);

3. The next smallest job is next identified and placed at the end of the list (to the right in the example of FIG. 4); and

4. Steps 2-3 are repeated for the remaining jobs.

For the example of FIG. 4, the set of tasks with processing times 1, 2, 3, 4, 5, 6, 7 will be ordered, left to right, as 6, 4, 2, 1, 3, 5, 7. The Yelf Spiral for an odd number of jobs is, then, a counter-clockwise spiral.

Jobs of equal processing time can be placed, when they come up as the next smallest, in any sequence one after the other. It is assumed that the time between ending a job and starting a new job is always the same or zero.

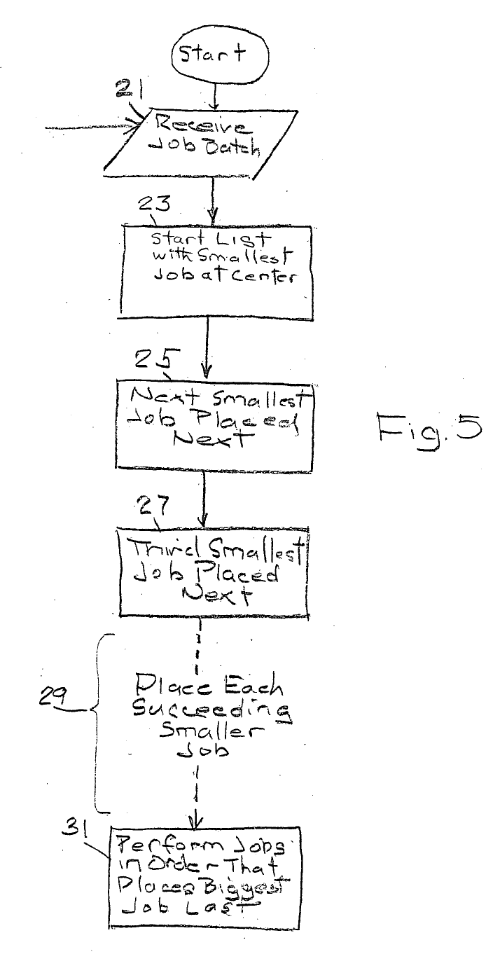

Described another way, the Yelf Spiral technique of job ordering can be considered to follow the steps shown in the flow chart of FIG. 5. A set or batch of job requests are received at 21, from, for example, the waiting buffer 16 of FIG. 1. The smallest job is first identified, at 23, and placed at the center of the list. The next smallest job is then placed in the list next to the smallest job, as indicated at 25. The third smallest job is placed on the list next to the smallest job but on the opposite side from the second smallest job as shown at 27. The remaining jobs are alternately placed to the left and right of the smallest job at 29, until all jobs have been placed on the list. The jobs are then performed, at 31, in the order that places the biggest job last.

Again placing the smallest, second, third or subsequent smallest job means, when several jobs of the same size are present, placing any one of these one after the other on the beginning and end of the list until there are no more jobs of that size.

In extensive testing of the Yelf Spiral method in comparison with many existing, popular scheduling methods, the Yelf Spiral has always produced the minimum variance of the job waiting times.

Whereas specific examples of the application of the jobs scheduling method of this invention have been described, these are not limiting, and further applications will be apparent to those skilled in the art within the spirit and scope of the invention claimed.

We claim:

1. A method of batch scheduled admission control for jobs to be performed at a resource for requesting entities comprising:
(a) receiving from requesting entities a plurality of job requests;
(b) assembling a number K₁, of the job requests into a first batch of a number N or less, job requests for performance by the resource;
(c) at a time t₁, beginning performance of the jobs in the first batch by the resource;
(d) retaining for a subsequent batch unperformed requested jobs;
(e) at a time t₂ when the jobs of the first batch have been performed; assembling a number K₂ of the unperformed requested jobs including the retained unperformed requested jobs and any subsequently received requested jobs into a second batch of a number N or less for performance by the resource; and
(f) repeating the assembling and performing as in step (e) for remaining unperformed jobs at times t₃ . . . tₙ, when each immediately preceding batch of jobs is completed.

2. The method of batch scheduled admission control according to claim 1 further comprising:
(g) calculating the time necessary to complete a batch of jobs to be performed;
(h) announcing to requesting entities the time that the next batch of jobs will be performed.

3. The method of batch scheduled admission control according to claim 1, further comprising applying to each batch of jobs a job scheduling algorithm that works on jobs arriving at the same time.

4. The method of batch scheduled admission control according to claim 1, wherein the resource is a computer resource, step (a) comprises storing received job requests in a first, waiting buffer, and steps (c) and (f) include loading each assembled batch of requested jobs into a second, processing buffer.

5. The method of batch scheduled admission control according to claim 4, wherein the computer resource and buffers are coupled to a computer network for receiving job requests from the network.

6. The method of batch scheduled admission control according to claim 5, wherein the computer resource is a server and the requesting entities are client computers coupled to the network.

7. The method of batch scheduled admission control according to claim 5, further comprising limiting the number of jobs in the waiting buffer to N if N jobs have been received prior to time T₂.

8. The method of batch scheduled admission control according to claim 1, further comprising continuing to receive jobs during processing of each batch, and limiting the number of jobs continuing to be received to that number of jobs bringing to a total of N unperformed requested jobs waiting to be performed.

9. The method of batch scheduled admission control according to claim 1, further comprising performing the jobs of each batch in an order represented by a job list having the biggest job last, the smallest job at substantially the center of the list and all jobs of intermediate size in increasing size alternately on one side of the smallest job and then the other side of the smallest job.

10. A method of job processing a set of jobs by a resource including performing the jobs in an order represented by a job list having the biggest job last, the smallest job at substantially the center of the list and all jobs of intermediate size in increasing size alternately on one side of the smallest job and then the other side of the smallest job.

11. A method of job ordering to minimize the variance in waiting time until job completion, comprising:
(a) receiving a set of jobs to be performed, the jobs ranging in size from smallest to largest;
(b) identifying the smallest job to be performed in the set of jobs;
(c) starting a list of the jobs to be performed beginning with the smallest job;
(d) identifying the second smallest job to be performed;
(e) adding the second smallest job to the list immediately next to the smallest job;
(f) identifying the third smallest job to be performed;
(g) adding the third smallest job to the list immediately next to the smallest job on the opposite side thereof from the second smallest job;
(h) identifying each succeeding smallest job and placing each succeeding smallest job next in the list, each on the opposite side of the smallest job from the last job placed on the list; and
(i) performing the jobs on the list in the order that places the largest job on the list last to be performed.

12. The method of job ordering according to claim 11, wherein the jobs are computer implemented jobs and the steps (a)-(i) are computer implemented steps.

13. The method of claim 12, wherein step (a) comprises receiving the set of jobs to be performed comprises:
(i) receiving jobs in a first buffer; and
(ii) regularly transferring the set of jobs as a batch to a second buffer; and steps (a)-(i) are repeated for each batch of jobs transferred to the second buffer.

14. The method of claim 12, further comprising, providing a server having a network connection, and step (a) comprises receiving job requests from computers in the network.

15. The method of claim 12, wherein the network is chosen from a group consisting of a global computer network, a wide area network (WAN), and a local area network (LAN).
